(19) United States
(12) Patent Application Publication
(10) Pub. No.: US 2024/0069174 A1
(43) Pub. Date: Feb. 29, 2024

(54) Dust Suppression Systems and Methods for Encapsulated Laser Scanners in Autonomous Drilling Machines

(71) Applicant: VIFMA SPA, Talca (CL)

(72) Inventor: Mauricio Pareja, Talca (CL)

(21) Appl. No.: 17/896,306

(22) Filed: Aug. 26, 2022

(51) Int. Cl. G01S 7/497; B23Q 11/00; G02B 27/00; E21B 7/02; E21B 47/00

(52) U.S. Cl. CPC G01S 7/497; B23Q 11/0046; G02B 27/0006; E21B 7/02; E21B 47/00; G01S 2007/4977

(57) ABSTRACT

A pneumatic system that eliminates stops due to dirt in the lasers of an Autonomous Drilling Machine uses the resources of the equipment (Compressed Air) to maintain a positive pressure inside the metal protectors of the lasers, thus preventing the entry of dust in suspension and keeping the lasers clean. This avoids unduly stops of the machine due to dust contamination. The system uses a pneumatic control board connected through a flexible line to the machine's compressor's manifold, a frame, a pressure regulator, and a filter. The protectors for the lasers have perforations that allow the installation of diffusors. The diffusors are installed in the protectors to allow entrance of contamination-free compressed air. A flexible line, with its fittings and couplings, connects the pneumatic control board to each of the diffusors.

### TECHNICAL FIELD

The present invention relates in general to drilling machines, and more particularly to pneumatic dust suppression systems and methods for encapsulated laser scanners in autonomous drilling machines and for other autonomous equipment that use laser scanners to detect obstacles.

### BACKGROUND OF THE INVENTION

There are many different types of drilling machines for drilling through a formation. Some of these drilling machines are mobile and others are stationary. Some examples of mobile and stationary drilling machines are disclosed in U.S. Pat. Nos. 3,245,180, 3,692,123, 3,708,024, 3,778,940, 3,815,690, 3,833,072, 3,905,168, 3,968,845, 3,992,831, 4,020,909, 4,170,340, 4,478,291, 4,595,065, 5,988,299, 6,672,410, 6,675,915, 7,325,634, 7,347,285 and 9,708,855. A typical mobile drilling machine includes a vehicle and tower, wherein the tower carries a rotary head and drill string. The rotary head is coupled with the tower using a feed cable system, wherein the feed cable system allows the rotary head to move between raised and lowered positions. In operation, the drill string is driven into the formation by the rotary head. In this way, the drilling machine drills through the formation. More information about drilling machines, and how they operate, can be found in the above-identified references.

Some examples of different types of drilling machines are the PV-235, PV-270, PV-271, PV-275 and PV-351 drilling machines, which are manufactured by Atlas Copco Drilling Solutions of Garland, Tex. It should be noted, however, that drilling machines are provided by many other manufacturers.

As shown in U.S. Pat. No. 9,594,376, and International Patent Application WO2010149853A1 some drilling machines utilize laser scanners to scan the surroundings in which the machine is travelling for obstacles, such as, for example, various rock walls. That is the case, for example, of drilling equipment with autonomous operation, such as EPIROC Model PV-351, PV-311, PV-271, PV-275, etc. CATERPILLAR MD6640, Komatsu trucks, caterpillar trucks, and many others. The contents of these cited patents are incorporated by reference as though fully set forth herein.

During the drilling process, a large amount of suspended dust is generated. For this condition. The ability of these laser scanners of differentiating between this excess of dust in the periphery of the equipment and a solid object (Obstacle) is limited. The laser scanners of these machines come with metallic laser protectors, but these are not able by themselves to effectively avoid the contamination of the readers, since dust enters the interior of the protection, causing a reading error, as the scanners confuse dust for an obstacle and unduly stop the machine. This generates the need to clean the scanners in the field unexpectedly hindering the autonomy of the operation. There are as well other kinds of equipment that use the same kind of laser sensors and that could also benefit from a pneumatic system that keeps them clean.

For this reason, a system and method that eliminate stops due to dirt in the lasers, using the resources of the equipment (Compressed Air) to maintain a positive pressure inside the metal protector of the laser, thus preventing the entry of dust in suspension and keeping the reader clean, would increase productivity in autonomous mode, significantly advancing the field.

### SUMMARY OF THE INVENTION

The main object of this invention is to obtain a system and method to prevent dust from entering inside the metal protectors of laser scanners in an autonomous drilling machine, to avoid unduly stops of the machine due to dust contamination.

Another object of this invention is to do so by using the resources of the equipment (Compressed Air) to maintain a positive pressure inside the metal protector of the laser.

A further object of this invention is to minimize and/or eliminate cleaning intervals, avoiding contamination in the laser scanners, since no dust enters the interior of the protectors, being practically maintenance free only needing to check the automatic water decanting system and the service pressures every 250 hours.

Yet another object of this invention is to provide a system that offers, in the event of part of the system being damaged, quick clean and effective repairs without needing special tools, thanks to the use of quick-connect fittings that do not require any connection tool and withstand up to 150 PSI of service pressure.

This Dust Suppression System for Encapsulated Laser Scanners in Autonomous Drilling Machines can be achieved by combining some or all of the following elements:
a. A pneumatic control board connected through an air supply line to the machine's compressor's manifold;
b. A frame for the pneumatic board;
c. A pressure regulator and filter;
d. Modified metallic protectors for the each of the laser scanners present in the machine, having perforations to allow the installation of one or more diffusors in the protectors;
e. Diffusors/Mufflers used to allow the entrance of contamination-free compressed air into the protectors.
f. A distributor block;
g. Flexible line hoses, fittings and couplings connecting the pneumatic control board to the diffusors in the protectors;
h. One-way restrictor valve(s), 2-way ball valve(s), ball valve(s) and/or other valves needed to regulate the passage of the required airflow of compressed air from the compressor to the diffusors in the protectors. To calculate this, the Volume used by the laser scanner inside the protection must be subtracted from the Inner volume metallic protection to get the Effective volume to be displaced inside the protection. The Expected flow in each protector at the desired pressure is obtained based on this Effective volume and then multiplied by the number of protectors present in the system to obtain the Total airflow required.

A method for the implementation of a Dust Suppression System for Encapsulated Laser Scanners in Autonomous Drilling Machines can be achieved by the following steps:
1. Manufacturing the modified metallic protectors with perforations for the each of the laser scanners present in the machine. This can be done by making perforations in the same protectors already present in the machine or by manufacturing new ones specifically created with this purpose;
2. Installing the diffusors in the wholes of the modified metallic protectors by screwing them and tightening them with nuts;
3. Positioning the drill rig on a dry, level surface;
4. Raising tower to upright position and locking it in place;
5. Stopping the engine of the machine;
6. Attaching security locks and safety labels to the machine in accordance with mine's specific procedures;
7. Ensuring zero power on all systems;
8. Replacing the original laser protectors by the modified laser protectors;
9. Installing the pneumatic control board and frame in a convenient location within the machine to reach all the lasers and the compressor with pneumatic lines;
10. Installing and connecting the air line from the compressor's manifold to the control board;
11. Locating the line hoses, fittings and couplings connecting the pneumatic control board to the diffusors in the protectors so that the pneumatic lines run down between the platform (Gratting) and the chassis of the machine.
12. Connecting the pneumatic lines, funneling a line to each of the laser protectors, taking care that the lines not cross each other;
13. Securing each of the lines to the structure of the laser supports.

### BRIEF DESCRIPTION OF THE DRAWINGS

FIG. 1 is a unilineal diagram of an embodiment of a Dust Suppression System for Encapsulated Laser Scanners in Autonomous Drilling Machines.

FIG. 2 shows different perspectives of a modified laser metal protector in an embodiment of a Dust Suppression System for Encapsulated Laser Scanners in Autonomous Drilling Machines, showing the location of the diffusors.

FIG. 3A is a perspective view of a diffusor for using it in an embodiment of a Dust Suppression System for Encapsulated Laser Scanners in Autonomous Drilling Machines.

FIG. 3B is a side view of a modified laser metal protector in an embodiment of a Dust Suppression System for Encapsulated Laser Scanners in Autonomous Drilling Machines, showing the location of the diffusors.

FIG. 3C is a front view of a modified laser metal protector in an embodiment of a Dust Suppression System for Encapsulated Laser Scanners in Autonomous Drilling Machines, showing the location of the diffusors.

FIG. 4 is a perspective view of a modified laser metal protector in an embodiment of a Dust Suppression System for Encapsulated Laser Scanners in Autonomous Drilling Machines, showing the fittings and air lines connected to it.

FIG. 5 is a distribution diagram of an embodiment of a Dust Suppression System for Encapsulated Laser Scanners in Autonomous Drilling Machines.

FIG. 6 is a is a distribution and installation diagram of an embodiment of a Dust Suppression System for Encapsulated Laser Scanners in Autonomous Drilling Machines showed in the example of a PV-351D machine.

### DETAILED DESCRIPTION AND BEST MODE OF IMPLEMENTATION

Definitions: In the context of this specification and claims, the word “machine” refers to a drilling machine for drilling through a formation, such as PV-235, PV-270, PV-271, PV-275 and PV-351 drilling machines, which are manufactured by Atlas Copco Drilling Solutions of Garland, Tex, EPIROC Model PV-351, PV-311, PV-271, PV-275, etc. CATERPILLAR MD6640, Komatsu trucks, caterpillar trucks, and many others. The word “laser” refers to the laser scanners some of these autonomous machines utilize to scan the surroundings in which the machine is travelling for obstacles. The word “lines” refers to pneumatic lines including flexible polymeric tubes and all the necessary fittings (couplings, connectors, end-fittings, clamps, etc.) for use with compressed air.

Some general aspects of the present invention have been summarized so far in the first part of this detailed description and in the previous sections of this disclosure. Hereinafter, a detailed description of the invention as illustrated in the drawings will be provided. While some aspects of the invention will be described in connection with these drawings, it is to be understood that the disclosed embodiments are merely illustrative of the invention, which may be embodied in various forms. The specific materials, methods, structures, and functional details disclosed herein are not to be interpreted as limiting. Instead, the intended function of this disclosure is to exemplify some of the ways—including the presently preferred ways—in which the invention, as defined by the claims, can be enabled for a Person of Ordinary Skill in the Art. Therefore, the intent of the present disclosure is to cover all variations encompassed within the spirit and scope of the invention as defined by the appended claims, and any reasonable equivalents thereof.

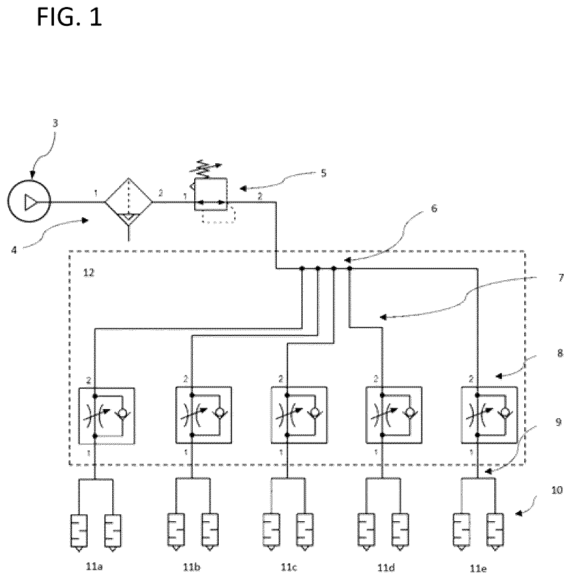

FIG. 1 is a unilineal diagram showing the entrance 1 and output 2 of compressed air from a compressor 3 into the compartments where the first laser 11a, second laser 11b, third laser 11c, fourth laser 11d, and fifth laser 11e, are located. In other embodiments, more or less lasers are present, and, as in the embodiment shown here, a line 7 connects the compressor 3 with each of them. The air passes through a filter 4 and a pressure regulator 5. This can be, for example, a FP300/XH pressure regulator filter, with Particle filter and moisture separator, 5μ, high pressure 300 PSI, Flow allowed 3000 L/Min, for in air control and automation systems outdoors, heavy duty. Other embodiments use different filters and/or pressure regulators with the objective of getting an airflow of 10 to 120 PSI into each of the protectors. In the preferred embodiment the ideal airflow is around 40 PSI, and it is calculated by subtracting the Volume used by the laser scanner inside the protection must from the Inner volume metallic protection to get the Effective volume to be displaced inside the protection. The Expected flow in each protector at the desired pressure is obtained based on this Effective volume and then multiplied by the number of protectors present in the system to obtain the Total airflow required. For example, for a PV-351 machine, the Inner volume metallic protection is of 6.25 Liters, and the Volume used by the laser scanner inside the protection is of 1.62 liters, therefore the Effective volume to be displaced inside the protection is of 4.63 liters, the Expected flow in each protection at 2.75 BAR (40 PSI) is of 150 liters/min and the Total airflow required (for five lasers) is of 750 liters/min. For a PV-351 drilling rig at 0 masl, a 3800 CFM compressor 3 is used, with a System Demand of 26.5 CFM. The pressurization system uses 0.7% of the total flow of the compressor 3. For a PV-351 drilling rig at 3,500 masl, a 2500 CFM compressor 3 is used, with a System Demand of 26.5 CFM. The pressurization system uses 1.06% of the total flow of the compressor 3. Other embodiments, instead of using the compressor 3 of the machine for air supply, use a different compressor 3 specially provided for this task. For example, an electric compressor. A distribution block 6 funnel the lines 7 to each of the lasers 11a-e, going through flow regulating valves 8 and distributor fittings 9. The fittings and valves needed will depend on each embodiment and will be evident for a person of ordinary skill in the art, who can easily derive a correct arrangement from the general knowledge by applying the teachings in this specification. A pneumatic board 12 regulates the flow of compressed air throughout the system.

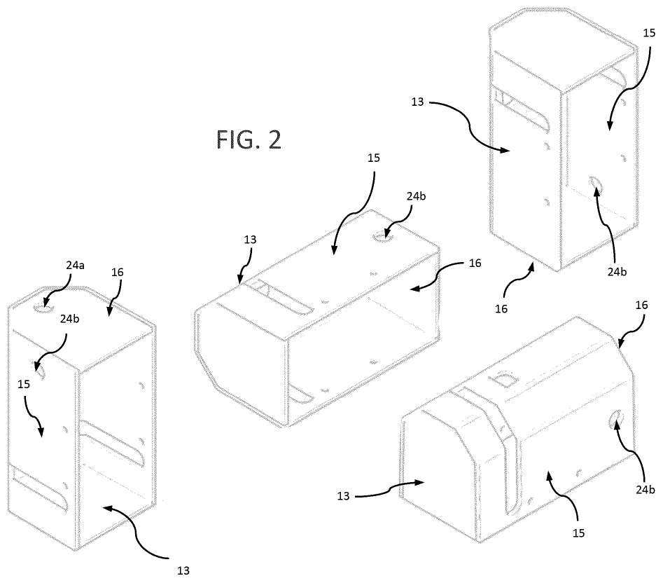

FIG. 2 shows different perspectives of a laser metal protector 13 which have been modified for the allowance of the passage of air in accordance with the present invention, to keep the laser 11 free of dust contaminants. For that, two perforations have been made to the protectors 13. A first perforation 24a in the top 16 of the protectors 13, and a second perforation 24b in the right-side wall 15 of the protector 13. Other embodiments have perforations in different locations as well as a different number of perforations to allow different arrangements of entrance of air, and other models of protectors 13 might need different adaptations. The right size for the perforations 24a-b is that that allows the correct installation of the diffusors 10. In the case of the Diffusor/muffler AMTE-G38, the diameter of the perforations 24a-b is of 19 mm

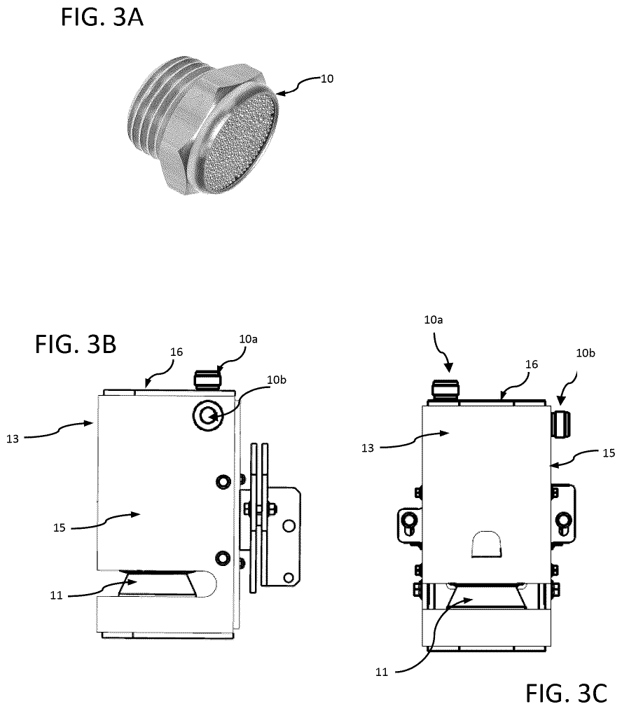

FIG. 3A shows a diffusor/muffler 10 of the type AMTE-G38 with the following characteristics:
Deposit size: 10
Major diameter: 19 mm
Symbol: 00991473
Operating pressure: 0 MPa . . . 1 MPa/0 bar . . . 10 bar
Flow against atmosphere: 1545 l/min
Operating medium: Compressed air according to ISO 8573-1:2010 [7:-:-]
Note on working/control medium: Can be used with lubricated compressed air
Corrosion resistance class CRC Sound pressure level: 1—low corrosion risk
Room temperature: −40° C. . . . 80°
Product weight: 17 g
Pneumatic connection: G3/8
Material of the damping insert: bronze
Material of the screwed pivot: brass

Other embodiments use different diffusors or injectors. In the case that an electric compressor which provides clean air is used the use of the diffuser can be avoided, since its main purpose is to clean the compressed air from pollutants which is unnecessary if the air is already clean.

FIGS. 3B and 3C show a modified protector 13, in which the laser 11 can be seen in its interior, and the location of the diffusors are shown, where the first diffusor 10a is shown on the top 16 of the protectors 13, inserted in the first perforation 24a shown in FIG. 2, and a second diffusor 10b is shown in the right-side wall 15 of the protector 13, inserted in the second perforation 24b shown in FIG. 2.

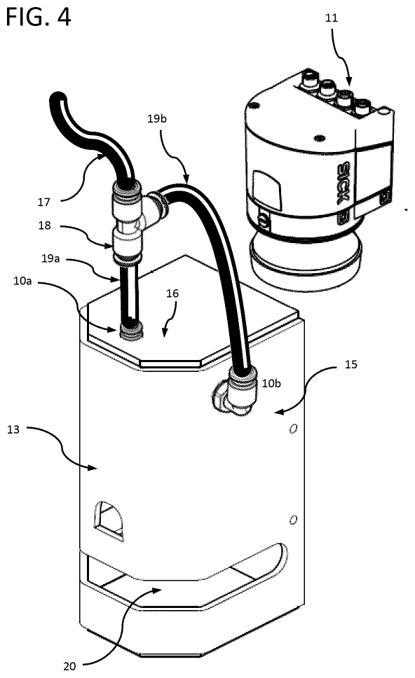

FIG. 4 displays a modified laser metal protector 13 and the fittings and air lines connected to it. A flexible line 17, which comes from the compressor 3, going through all the necessary the filters, flow regulators and valves, is separated in two lines with the use of a “T” fitting 18. The first of these lines, 19a is connected to the first diffusor 10a, and the second of these lines, 19b is connected to the second diffusor 10b. The laser 11 goes in the interior 20 of the protector 13.

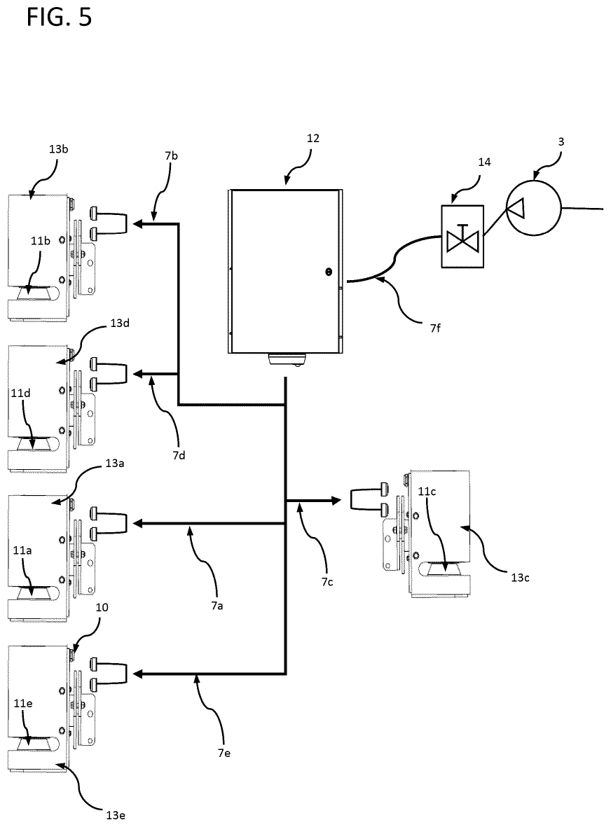

FIG. 5 is a distribution diagram showing the pneumatic panel 12, connected through a line 7f to the manifold valve 14 of the compressor 3, and also connected through line 7a to the protector 13a of laser 11a, through line 7b to the protector 13b of laser 11b, through line 7c to the protector 13c of laser 11c, through line 7d to the protector 13d of laser 11d, and through line 7e to the protector 13e of laser 11e.

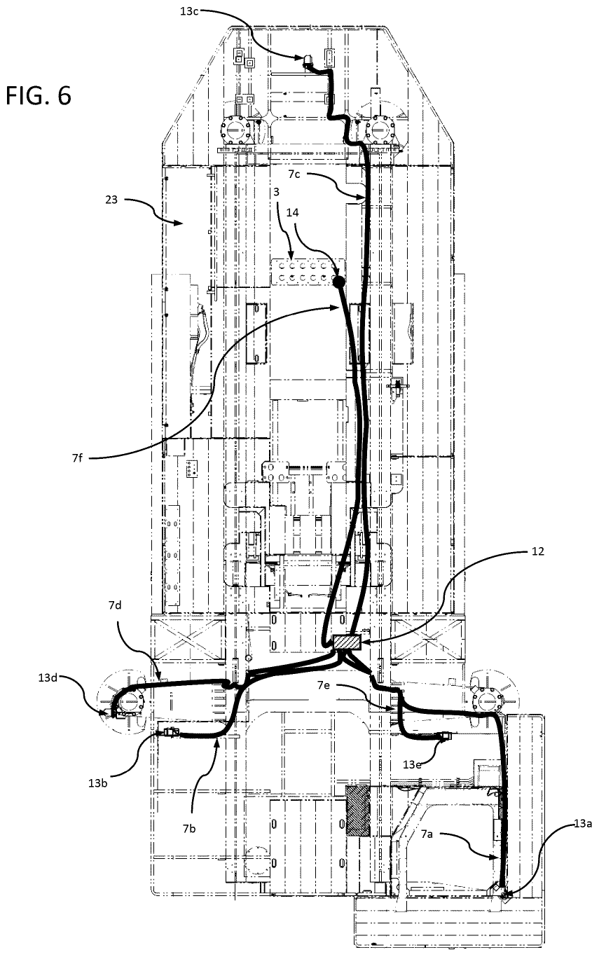

Lastly, FIG. 6 is a distribution diagram showing the system applied to a PV-351D machine 23. The pneumatic panel 12, is connected through a line 7f to the manifold valve 14 of the compressor 3, and also connected through line 7a to the protector 13a, through line 7b to the protector 13b, through line 7c to the protector 13c, through line 7d to the protector 13d, and through line 7e to the protector 13e.

The description as set forth is not intended to be exhaustive or to limit the invention to the precise form disclosed. Many modifications and variations are possible in light of the teachings above without departing from the spirit and scope of the forthcoming claims.

1. A pneumatic dust suppression system for Laser Scanners in an Autonomous Drilling Machine, said pneumatic dust suppression system comprising:
a. a pneumatic control board connected through a flexible line to the machine's compressor's manifold;
b. a frame for the pneumatic board;
c. a pressure regulator and filter;
d. a protector for each laser present in the machine, said protector having perforations to allow installation of one or more diffusors per protector;
e. a plurality of diffusors installed in said perforations to allow entrance of contamination-free compressed air into said protectors;
f. a flexible line, fittings and couplings connecting said pneumatic control board to each of said diffusors; and
g. a plurality of valves to regulate the passage of compressed air from said compressor to said diffusors obtaining an airflow of 10 to 120 PSI into each of the protectors.
